(19) United States
(12) Patent Application Publication
(10) Pub. No.: US 2002/0111791 A1
(43) Pub. Date: Aug. 15, 2002

(54) Method and apparatus for communicating with people who speak a foreign language

(75) Inventor: Brant L. Candelore, Escondido, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Corporation and Sony Electronics Inc.

(21) Appl. No.: 09/784,247

(22) Filed: Feb. 15, 2001

(51) Int. Cl. G06F 17/28

(52) U.S. Cl. 704/7

(57) ABSTRACT

A method of communicating with another person, or “helper”, who speaks a foreign, or “target”, language. The method includes using a device having a speaker to play instructions and phrases in the target language. The phrases query the helper and can include canned phrases that are pre-programmed on the CD-ROM and user programmed custom phrases stored in the EEPROM. The instructions request the helper to respond to the phrases not in his or her own (or target) language, but rather with head movements, hand gestures such as pointing, drawings, or any other non-verbal response or “universal” method that does not require the traveler to understand the target language.

### BACKGROUND OF THE INVENTION

1. Field of the Invention

The present invention relates generally to translating devices, and more specifically to electronic devices that aid in communicating with people who speak a foreign language.

2. Discussion of the Related Art

One of the primary difficulties of traveling abroad is trying to communicate with people who speak a different language. Westerners seem to have increased difficulty with Asian languages. Unfortunately, Asian languages are not emphasized in western schools that offer foreign language instruction. Usually languages such as French and Spanish are stressed over languages such as Japanese, Chinese, Korean, or Vietnamese. In some cases, schools are foregoing even that type of instruction for the more basic “core” topics such as reading, writing, and arithmetic.

Consequently, visiting an Asian country can be quite intimidating to an untrained western visitor from a linguistic point of view. In many cases, the host language has no familiar lettering that the westerner can recognize. Often, words are represented by symbols or pictures and are not composed of letters, which have a set pronunciation. Words have completely different roots, and their pronunciation sounds different. To make matters more difficult, differences in culture mean that there are fewer clues as to what signs, gestures and acts might mean. Thus, a person visiting an Asian country under short notice may have a very difficult time. He or she may experience a great deal of frustration along with periods of feeling completely lost. Similarly, an Asian visitor in the United States who does not speak English may encounter many of these same problems.

One way around the problem is to have a knowledgeable person accompany the person. Such translators, if done on a professional basis, are quite expensive. Similarly, tourist areas often have English speakers, which is fortunate for English speaking people but not for people who speak other languages. Less touristy and less frequently traveled areas many not have such speakers, which leaves the traveler on his or her own to communicate.

Another solution is for the traveler to take foreign language classes to try and learn a language in order to communicate with others. However, substantial study is needed to operate even at a rudimentary level. For example, just to be able to get by (e.g., to order food in a restaurant, to command lodging in a hotel, or to catch a taxi), there is often a great deal of language and cultural study required.

Translation devices have been used in the past to help travelers communicate while in foreign countries or just to help two or more people communicate when they lack a common language. An English/Spanish dictionary is one example of a device that assists people in communicating with each other. A phrase book is another example. However, most phrase books and translator devices assume some knowledge of the foreign language. For example, phrase books typically assume some basic knowledge such as “yes/no”, helping verbs (such as to be, to go, to have), basic verbs (to eat, to live), etc. Without this knowledge, while it may be possible to read a sentence out of a phrase book, it is not always possible to understand the reply. The native person even when warned to speak slowly will often forget that he or she is speaking to a foreigner and blurt out responses as he or she would to another native person, making it very hard for the foreigner to understand.

Some phrase books have the foreign language written in them so that the traveler can merely point to a phrase. Some of the possible replies are listed below the phrase, and the native need only point to the reply, which also has the corresponding original language next to it. One problem with these phrase books, however, is that it is awkward to get the native in a position to use the phrase book. The native must be shown the book, and then the specific entry on the page to which the book is opened. There is a period of time when gestures and hand pointing is used to show the native what is intended. While most people do want to help to some extent, some have more patience than others. After a while some will simply smile, shrug their shoulders, and then walk away. This is because it is not clear on what the native is being instructed to do.

An additional problem with such phrase books is that they are hard for people to read and use efficiently. They may contain many phrases on a single page. The type in such books if often of font size 8 to 10 making it very hard to read. And often the phrases do not cover enough scenarios and possible responses. Furthermore, it may take a long time to find multiple questions, frustrating the individual that is trying to help.

Thus, there is a need for a translator device which overcomes these and other disadvantages.

### SUMMARY OF THE INVENTION

The present invention advantageously addresses the needs above as well as other needs by providing a method of communicating. The method includes the steps of: receiving one or more input commands in a communication device; playing instructions in a target language from the communication device in response to a received input command, the instructions request a non-verbal response to a phrase; receiving a selection of the phrase from a list of phrases in a user's language; and playing the phrase in the target language from the communication device.

The present invention also provides an apparatus for communicating. The apparatus includes input controls for receiving commands from a user, a speaker, and a processing system. The processing system is configured to play instructions in a target language from the speaker in response to interaction with the input controls. The instructions request a non-verbal response to a phrase. The processing system is further configured to receive a selection of the phrase from a list of phrases in a user's language and to play the phrase in the target language from the speaker.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof presented in conjunction with the following drawings herein;

FIGS. 1A and 1B are front and rear views, respectively, illustrating a communication device made in accordance with the present invention;

FIG. 2 is a block diagram illustrating an architecture that may be used in the communication device shown in FIGS. 1A and 1B;

FIG. 3 is a flow diagram illustrating an exemplary main operation in accordance with one embodiment of the present invention that maybe used by the communication device shown in FIGS. 1A and 1B;

FIG. 4 is a flow diagram illustrating an exemplary process that may be used for the play instructions step shown in FIG. 3;

FIG. 5 is a flow diagram illustrating one type of non-verbal response process in accordance with one embodiment of the present invention;

FIGS. 6 and 7 are screen shots illustrating an exemplary implementation of the non-verbal response process shown in FIG. 5;

FIG. 8 is a flow diagram illustrating an exemplary process that may be used for the select a category step shown in FIG. 3;

FIG. 9 is a flow diagram illustrating an exemplary process that may be used for the select a question or phrase step shown in FIG. 3;

FIG. 10 is a flow diagram illustrating an exemplary process in accordance with one embodiment of the present invention for programming custom phrases into the communication device shown in FIGS. 1A and 1B;

FIG. 11 is a flow diagram illustrating an exemplary process in accordance with one embodiment of the present invention for entering setup information into the communication device shown in FIGS. 1A and 1B;

FIGS. 12A and 12B are flow diagrams illustrating exemplary processes in accordance with one embodiment of the present invention for setting up and using information categories in the communication device shown in FIGS. 1A and 1B; and

FIGS. 13A and 13B are tables illustrating an example of a type of categorization that may be used for implementing the processes shown in FIGS. 12A and 12B.

Corresponding reference characters indicate corresponding components throughout the drawings.

### DETAILED DESCRIPTION OF A PREFERRED EMBODIMENT

The following description is not to be taken in a limiting sense, but is made for the purpose of describing the general principles of the invention. The scope of the invention should be determined with reference to the claims.

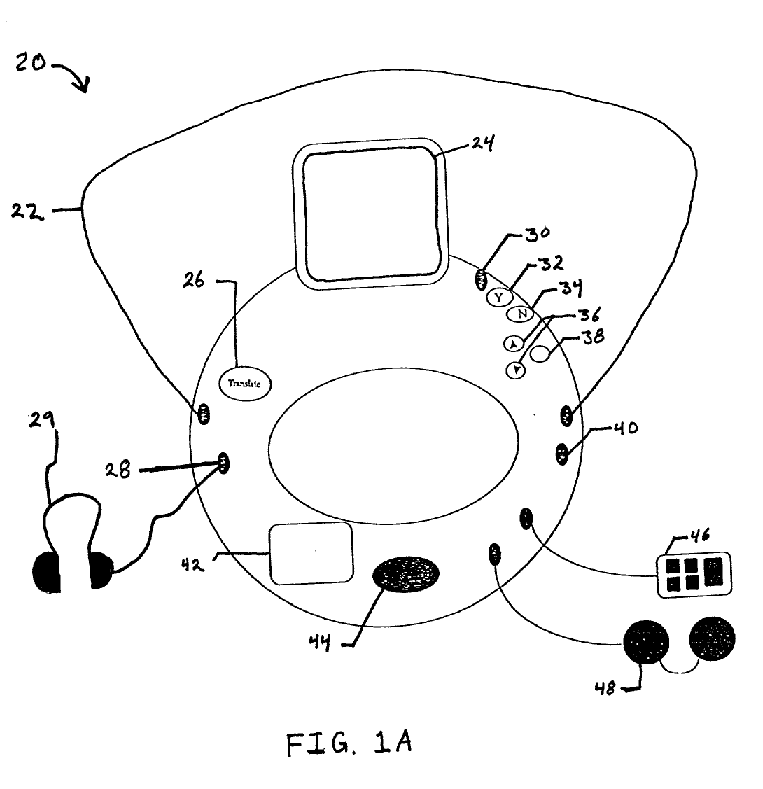

Referring to FIG. 1, there is illustrated a communication device 20 made in accordance with one embodiment of the present invention. The communication device 20 overcomes the disadvantages described above. Specifically, the communication device 20 can be used by a user to assist him or her in communicating with people who speak a language that is foreign to the user. Very little knowledge of the foreign language, if any at all, is needed by the user in order to communicate using the device 20. Furthermore, the communication device 20 can be used for communicating in many different foreign languages. The device 20 can be quickly reconfigured to change from one foreign language to the next. This feature is particularly useful when the user is on a journey that takes him or her through several different countries.

In general, the communication device 20 operates by playing instructions in a foreign language instructing a person who understands the foreign language to use non-verbal responses to respond to questions or phrases that are also played from the device 20 in the foreign language. This operation will be described in greater detail below, and the following terminology will be used in that description.

Specifically, the term “user” is used to refer to the person trying to communicate by using the device 20. A typical scenario involves the user traveling to a foreign country, and thus, the user may also be referred to as a traveler.

The term “target language” is used to refer to the foreign language. In other words, the target language is the language that the user does not understand and is the language in which the user is trying to communicate. The target language will often be referred as the host language, meaning the language of the country hosting the user or traveler.

The term “user's language” is used to refer to the user's native language or the user's preferred language that he or she does understand in both written and spoken form.

The term “helper” is used to refer to the person who understands the target (or foreign) language and who provides the user with the non-verbal responses. In other words, the helper is the person who the user approaches (or is approached by) and with whom the user is attempting to communicate. The helper will often be a native of the host country.

The term “phrase” is intended to include statements, questions, one or more words, etc. Phrases include the audio words played by the device 20 in the target language for communicating with the helper.

Thus, the communication device 20 assists the user in communicating with the helper when the two do not speak a common language. The helper is queried in his or her own language and is instructed to respond in a non-verbal method. In one exemplary scenario, the user is an English speaking person who is traveling in Japan. The target language is Japanese, and the user's language is English. The helper is a Japanese speaking person who does not understand English.

The communication device 20 is preferably portable such that the user can easily carry the device 20. Ideally, a neck strap 22 is included so that the user can hang the device 20 around his or her neck, but this is not required. The neck strap 22 makes it convenient for a traveler to carry the communication device 20 while on business or vacation in a foreign country. The communication device 20 hanging around the user's neck could indicate to others that the user can not speak the target language (e.g. Japanese), which may make potential helpers more willing to help the user.

The communication device 20 preferably includes a speaker 50. The speaker 50 is used to play instructions, and phrases, in the target language for the helper to hear. Thus, by using the speaker 50 the user is effectively able to speak to the helper in the target language. As an optional feature, headphones 29 could be plugged into a headphone jack 28 so that the user could listen to the phrase in the user's language while the same phrase is being played in the target language over the speaker 50. This allows the user and helper to hear the same phrase at the same time. If multiple phrases or questions were being played by the communication device 20, the user and helper would not have a misunderstanding as to what was being responded to at that time. The user is able to gauge the response of the helper better since the user and helper will be at the same step in the questioning. As an optional feature, the speaker 50 may also be used for listening to music. As another optional feature, the communication device 20 could output the instructions and phrases through a built-in on screen display, external on screen display, universal serial bus, wireless interface, IEEE 1394, infrared interface, or serial interface.

The communication device 20 preferably includes a display 24. The display 24 is used to allow the user to interact with the device 20 via text that is written in the user's language. One function of the display 24 is to display lists of phrases for the user to select. These lists provide word choices for programming phrases. The lists of phrases are typically displayed in the user's language so that the user can read them. In one exemplary design the display 24 comprises a Liquid Crystal Display (LCD). As an optional feature a television jack 30 may be included to connect a remote display. Optional functions of the display 24 include providing text descriptions of the history and culture of various countries, as well as pictures of statues, maps, etc.

In the illustrated embodiment several buttons are included and are used by the user to interact with the device 20. Specifically, scroll buttons 36 are used for scrolling up and down a list on the display 24. A menu button 38 is used for selecting menus. A set of yes/no buttons 32, 34 are used for making selections. A translate button 26 may be included that is used to change a phrase from the user's language (e.g. English) to the target language (e.g. Japanese) and optionally back to the user's language. Additional buttons 54 may be included that are used to select from a list of multiple choice answers displayed on the display 24. A keypad jack 40 may be included to connect a remote keypad. Optionally, the inputs from the user could come from an external keyboard, internal microphone, wireless interface, universal serial bus, IEEE 1394, infrared interface, or serial interface.

Additional optional features for the communication device 20 include a microphone 44, a remote control 46, a pad of paper 42, and goggles 48. The microphone 44 can be used for recording custom phrases and instructions, which will be discussed below. The remote control 46 can be used for controlling the device 20 from a distance. The paper pad 42 may be used for writing down any information that either the user or the helper would like to communicate. For example, if the user asks “what time is it?”, the helper can draw a clock on the pad of paper 42 showing the current time. The goggles 48 may be used for virtual reality interaction with the communication device 20, such as for virtual reality games. An LCD may be included in the goggles 48. Goggles 48 make the device 20 particularly useful for therapy such as relaxation, yoga, prayer, visualization exercises, self help, motivational exercises, etc.

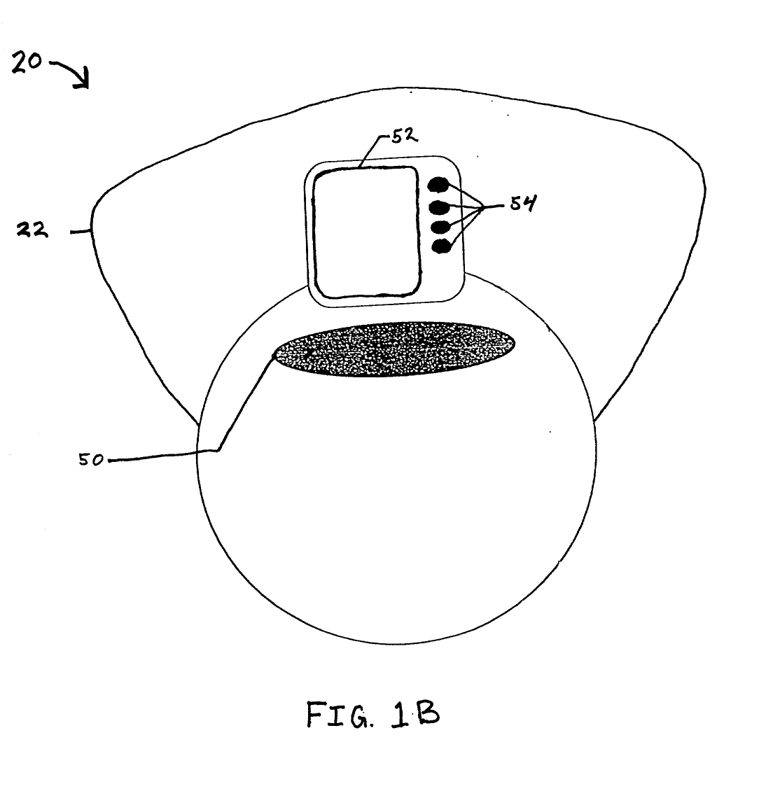

Referring to FIG. 2, there is illustrated an exemplary hardware architecture for a processing system that may be used for implementing the communication device 20. In general, the device 20 is preferably programmable based on the user's language. The system implements a voice synthesizer that simulates or uses a male or female voice for playback of recorded voice tracks stored as audio files. The display 70, control buttons 74, main speaker 76, and headphone speaker 78 are represented in the architecture. In addition, the architecture preferably includes a central processing unit (CPU) 72, a read only memory (ROM) 80, a random access memory (RAM) 82, a compact disc (CD) ROM 84, and an electrically erasable programmable read only memory (EEPROM) 86. The CPU 72 controls the operation of the communication device 20. The ROM 80, RAM 82, CD-ROM 84 and EEPROM 86 are used for memory and program storage. Specifically, the ROM 84 may be used for storing boot code and low level drivers for the device 20. The RAM 82 will typically be used as the working memory for the CPU 72.

The CD-ROM 84, or other similar type of memory, is preferably included. The CD-ROM 84 is used to access a large database that typically includes canned phrases and can even include a dictionary. The CD-ROM 84 can be used to store instructions and predetermined or “canned” phrases. The instructions/phrases are typically stored on a CD in the form of audio files in the target language. In addition, the various different instructions/phrases are typically categorized and identified by corresponding text and/or audio files in the user's language that are also stored on the CD. This way, the user can insert a CD into the device 20, view the different instructions/phrases on the display 24 in the user's language, select one or more and then play the selected instructions/phrases through the speaker 50 in the target language. The helper will understand the selected instructions/phrases because they are played in the target language. By way of example, the audio files may be encoded in the well-known WAV, MP3, or other format.

Each CD can be conveniently classified according to its user language/target language. For example, an English/Japanese CD is intended for a user who speaks and reads English and who is trying to communicate with people who speak Japanese. Such CD will typically include the instructions/phrases in English text so that the user can view them on the display 24 and select from them, and the CD will also include the instructions/phrases in Japanese audio files for the helper to hear. As another example, a Chinese/French CD is intended for a user who speaks and reads Chinese and who is trying to communicate with people who speak French. Such CD will typically include the instructions/phrases in Chinese text so that the user can view them on the display 24 and select from them, and the CD will also include the instructions/phrases in French audio files for the helper to hear.

Advantageously, the CD-ROM 84, or other similar type of memory, allows the device 20 to be quickly reconfigured to change from one foreign language to the next. Specifically, a user can carry different CDs that each store instructions/phrases for different target languages. For example, a Spanish speaking user traveling through Asia might carry a Spanish/Japanese CD, a Spanish/Chinese CD, a Spanish/Taiwanese CD, a Spanish/Vietnamese CD, etc. The user would simply insert the appropriate CD into the communication device 20 as the user enters each country. Optionally, a single CD could be programed to have multiple target languages, which would eliminate the need for the user to change CDs when entering a different country. Custom CDs having several different target languages could be made using, for example, the popular CD recordable (CD-R), CD rewriteable (CD-RW), or similar technologies.

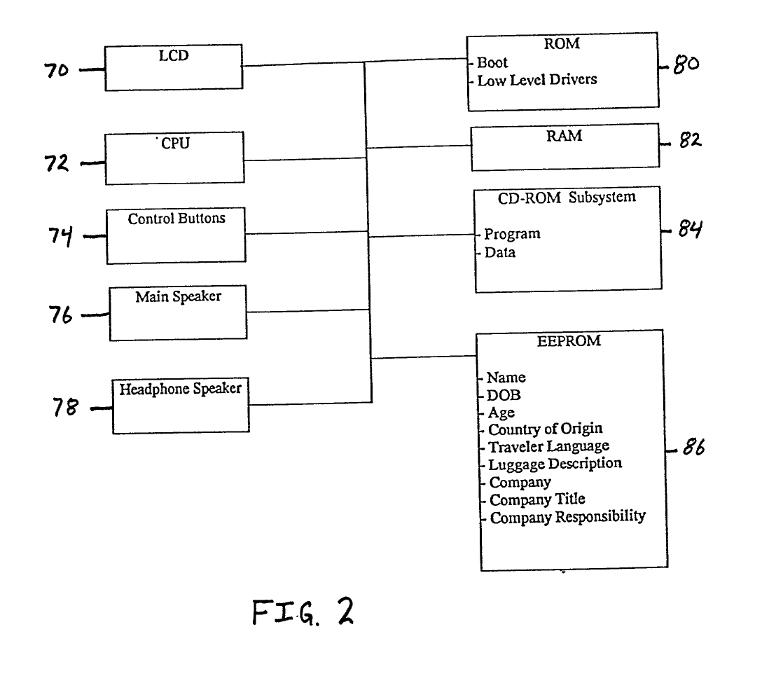

Referring to FIG. 3, there is illustrated an exemplary method of communicating 200 in accordance with an embodiment of the present invention. This method is ideal for use in the communication device 20. In a typical scenario, a user holding the device 20 approaches a potential helper.

The user interacts with the controls of the device 20 in order to initiate the method 200. In step 202 the instructions are played, preferably from the speaker 50. The instructions are played in the target language so that the helper understands them. Ideally, the instructions include a short introductory phrase explaining that the user cannot speak the target language. The instructions then go on to ask or instruct the helper to use non-verbal responses to respond to phrases that either will be, or have already been, played in the target language. In other words, the helper is instructed to respond not in his or her own language, but rather with head movements, hand gestures such as pointing, drawings, or any other “universal” method that does not require the traveler to understand the target language. These types of responses are included in a type of response referred to herein as a non-verbal response.

The following are exemplary instructions that may be played during step 202. The instructions request non-verbal responses and describe to the helper the manner in which to respond. As will be discussed below, either all or selected ones of these instructions may be played. It should be understood that these are only example instructions and that many other types of instructions may be used in accordance with the present invention.

INTRODUCTORY PHRASE USED WITH ALL MEETINGS:

“Hello, I am from the United States. I don't speak Japanese. Would you be so kind as to help me? All you have to do is follow some simple instructions.”

INSTRUCTIONS FOR YES/NO QUESTIONS:

“Please answer ‘NO’ by shaking your head from side to side. Please answer ‘YES’ by shaking your head up and down. Please answer ‘I don't know’ by shrugging your shoulders.”

INSTRUCTIONS FOR GIVING DIRECTIONS:

“If the answer is straight ahead, then please put your right hand out straight in front of you. If the answer is to the left, then please raise your left arm to the left. If the answer is to the right, then please raise your right arm.”

INSTRUCTIONS FOR NUMBERS:

“Can you write the numbers down in Romaji, please?”.

INSTRUCTIONS FOR GIVING TIME:

“Please draw the time as a circle with 12 hours on it, showing the Big Hand and Little Hand”

With respect to the above instructions and the phrases that will be discussed below, the text in quotes is played in the target language to the helper. The text in <> are instructions to the user for operating the device 20. The underlined words may be programmed into the device 20 or chosen from a secondary list. Secondary lists, as well as the programming of personal information into the device 20 will be described below.

In step 204 the user selects a category from which he or she wishes to choose a phrase. The categories preferably include many typical situations that a traveler might encounter while on a social or business trip where translation is needed. By way of example, the following categories could be used: ARRIVAL; DEPARTURE; TRAVELING AROUND; TAXI; BUSINESS; BASIC EXPRESSIONS; POST OFFICE; BANK; HOTEL; SHOPPING; RESTAURANT; MOVIE & THEATER; DOCTOR; BASIC NEEDS. As will be discussed below, the user preferably selects the category by scrolling through a list of categories on the display 24 and selecting one.

In step 206 the user selects a phrase that will be played. Again, as used herein the term “phrase” includes statements, questions, one or more words, etc. The phrase is preferably selected by scrolling through a list of phrases for the selected category on the display 24 and selecting one. The list of phrases will normally be displayed in the user's language so that the user can read them.

Step 208 represents an alternative, or even an additional, for playing the instructions that were played in step 202. In this alternative configuration the instructions could be played after a phrase has been selected in step 206 and just before the phrase is actually played. This scheme has the advantage of minimizing the amount of time needed from the helper in that the helper will not have to listen to the instructions and then wait while the user selects a phrase. Instead, the user can select the phrase prior to even approaching a helper, and then once the user finds a helper, the user can quickly play both the instructions and the phrase. The helper will be more likely to assist the user if it can be done very quickly.

In step 210 the phrase is played, preferably through the speaker 50. The phrase will normally be played in the target language so that the helper can understand it. The helper is queried with phrases played by the device 20 that are in the helper's own language, i.e., the target language. The phrases can include canned phrases that are pre-programmed on the CD-ROM 84 and user programmed custom phrases stored in the EEPROM 86. In step 212 the user is given the option to replay the phrase. This is useful, for example, if the helper did not understand the phrase. In addition, optional step 214 can be used for repeating the instructions. This allows the user to also replay the instructions just prior to replaying the phrase, which is useful for the scenario where the helper does not understand the entire situation the first time. If the user does not want to replay the phrase, then in step 216 the user preferably has the option of changing to a new category in order to select another phrase. If the user decides to change the category, then in step 218 the user preferably has the option to repeat the instructions before a new category is selected.

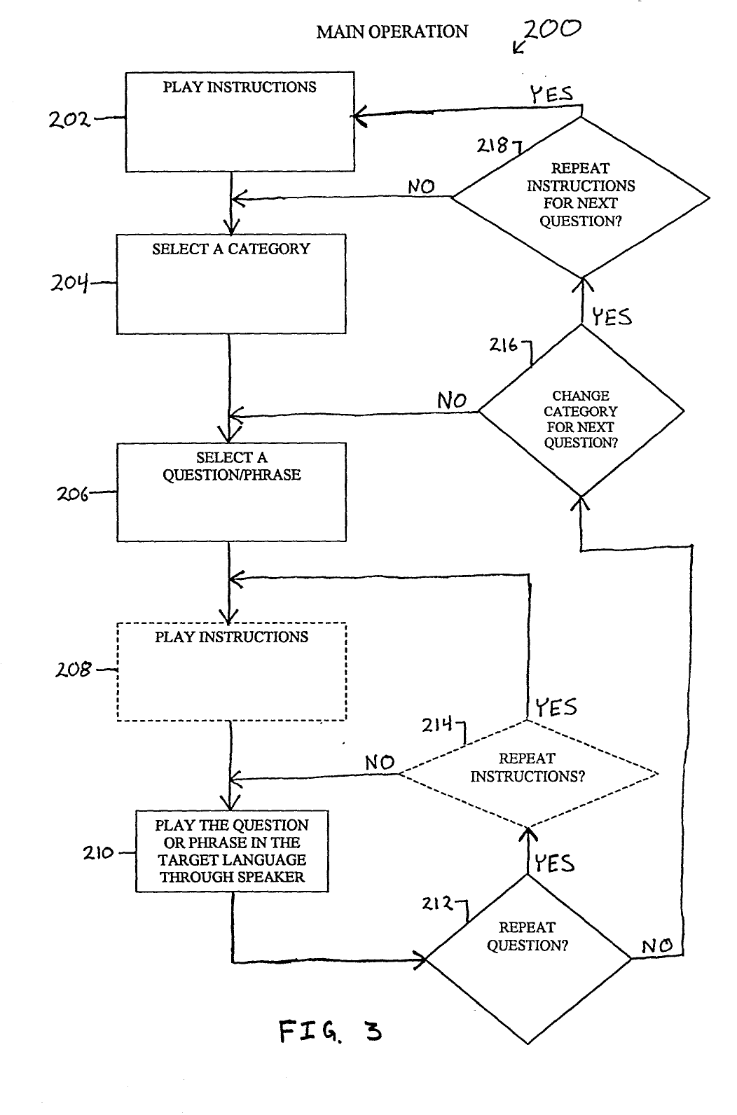

Referring to FIG. 4, there is illustrated an exemplary process that may be used for implementing the play instructions step 202 in the main operation 200. In step 302 the user interacts with the device 20 in order to activate the play instructions process. This interaction typically involves the user pressing one or more of the buttons 36, 38. It was mentioned above that either all or selected ones of the listed exemplary instructions may be played. In step 304 the user is given a chance to decide whether or not all of the instructions should be played, as opposed to only some of the instructions. This choice is preferably displayed on the display 24 for the user to view.

If the user elects to have the device 20 play all of the instructions, then the system, such as the CPU based architecture described above, enters a play all instructions mode. Specifically, the system selects or prepares all of the instructions to be played in step 306. This selection or preparation involves retrieving the audio files for all of the instructions from the CD-ROM 84. In step 308 all of the instructions are played audibly.

If the user wishes to have only certain instructions played, then the system enters a mode where not all of the instructions are played. In step 310 the user is given the option of having the system automatically select certain instructions for playing. If the user chooses the automatic selection mode, then in step 312 the system selects the instructions that will be played. The automatic selection is based on the specific phrase that the user selects. In other words, the system selects one or more instructions that are appropriate for the user's selected phrase. Thus, in this mode the user will typically have to select a phrase to be played before the system can automatically select which instruction to play. The system then determines which instructions would be helpful depending on the phrase selected by the user. For example, if the user's selected phrase is, “Is the bank open today?”, the system will preferably select instructions on how to respond to a “YES” and “NO” question, and the system could also play instructions on how to give a “time” response. The helper may want only to respond with a “YES” or “NO” and be on his or her way, or the helper may wish to provide the hours in which the bank will be open that day. In any event, the automatically selected instructions are played in the target language in step 308.

If the user does not choose the automatic selection mode in step 310, then the system enters a manual selection mode where the user manually selects the instructions that will be played. Specifically, in step 314 the system retrieves a list of instructions. The list is retrieved from the CD-ROM 84 and/or EEPROM 86 and/or a similar type of memory. In step 316 the list of instructions is displayed on the display 24 so that the user can view the list. The list is displayed in the user's language so that the user can read the list. The user selects the specific instructions that are to be played in step 318. The user's selected instructions are then played in the target language in step 308.

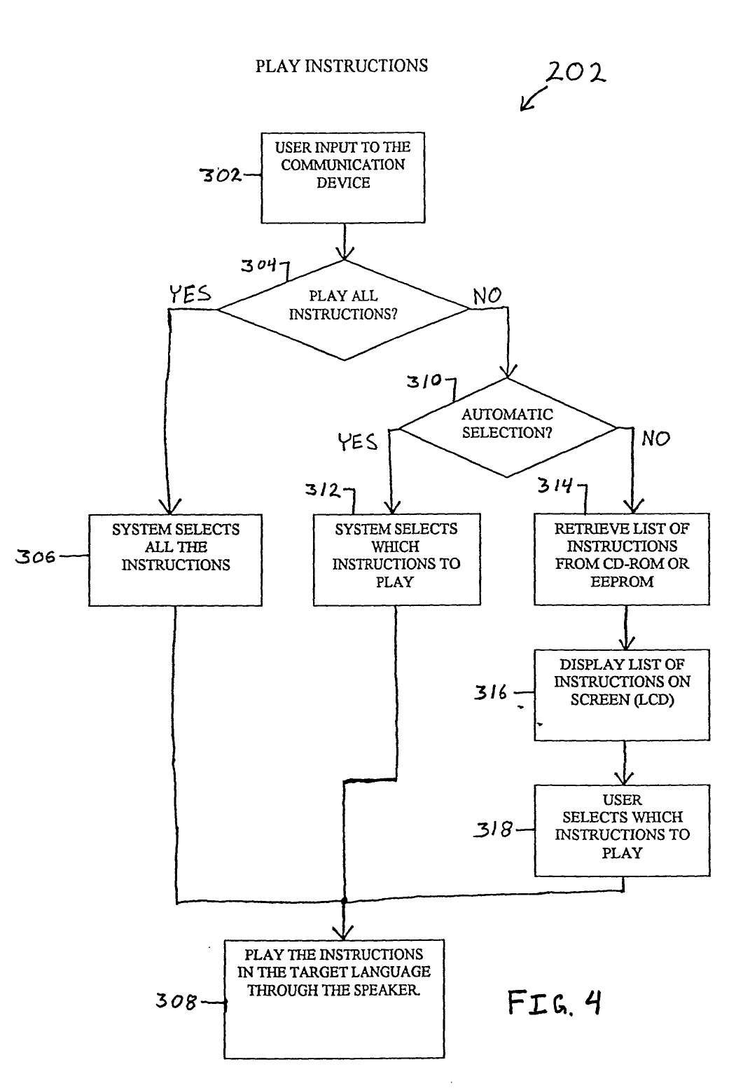

Referring to FIG. 5, there is illustrated a process for providing an alternative type of non-verbal response in accordance with an embodiment of the present invention. In this process the helper interacts with the communication device 20 to provide a response to the user's phrase. Specifically, after the user plays a phrase and the instructions, the device 20 displays possible responses to the phrase in step 402. The responses are preferably displayed on a display 52 that the helper can view. By way of example, this display 52 could be the same display 24 that the user views or a second display 52 on an opposite side of the device 20 easily viewable by the helper. The responses are preferably displayed in the target language so that the helper can read them.

In step 404 the helper selects one of the displayed possible responses by interacting with the device 20, for example by pressing a button corresponding to the desired response. In step 406 the helper is asked whether or not the response is complete. The helper is given the option to make additional selections because some responses may require more than one selection. If the response is not complete, step 404 is repeated so that the helper can make another selection. Once the response is complete, either the user or the helper pushes the translate button. This causes the system to translate the response into the user's language in step 408. The response is then displayed on the user's display 24 in step 410 and the user reads the response.

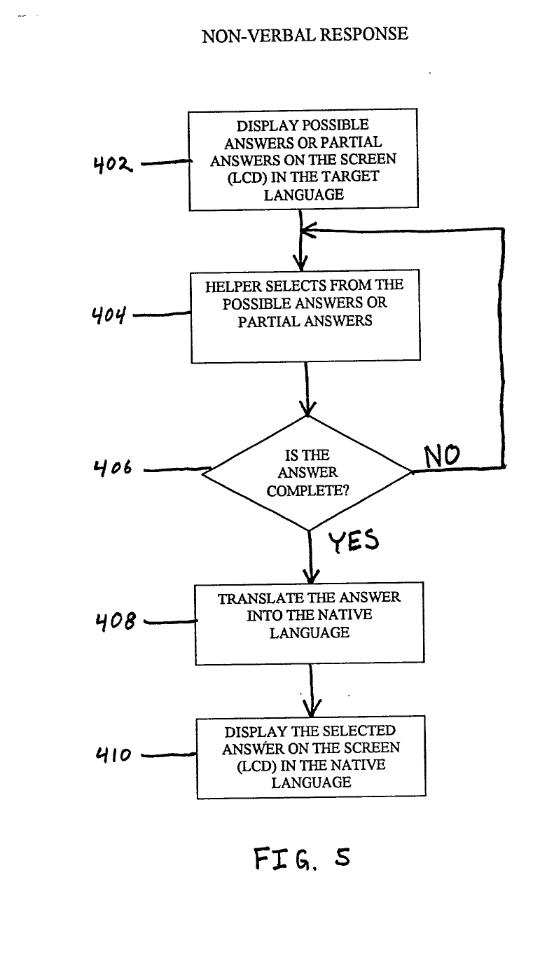

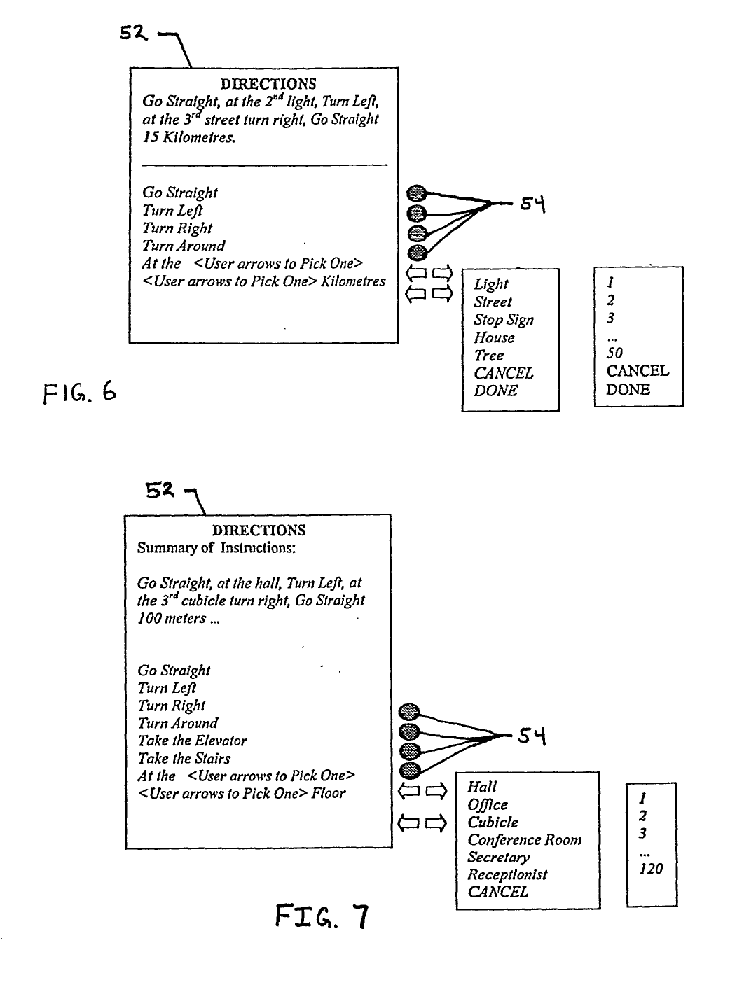

FIGS. 6 and 7 illustrate exemplary screen shots 52 that may be used for implementing the process shown in FIG. 5. Specifically, FIG. 6 shows possible responses from which a helper could select when responding to a user's phrase that requests directions outside on city streets. FIG. 7 shows possible responses from which a helper could select when responding to a user's phrase that requests directions inside of a building. The illustrated partial responses are combined to form a complete response to the request for directions. In accordance with the above-described process of FIG. 5 the helper selects partial responses and continues to select partial responses until the full response is complete. For example, the helper would be able to construct the sentence “Go straight, at the 2^{nd} light turn left, at the 3^{rd} street turn right, go straight 15 kilometers.” After the sentence is constructed, the user or helper pushes the translate button 26 and the device 20 translates the sentence into the user's language and displays it on the display 24 for the user to read.

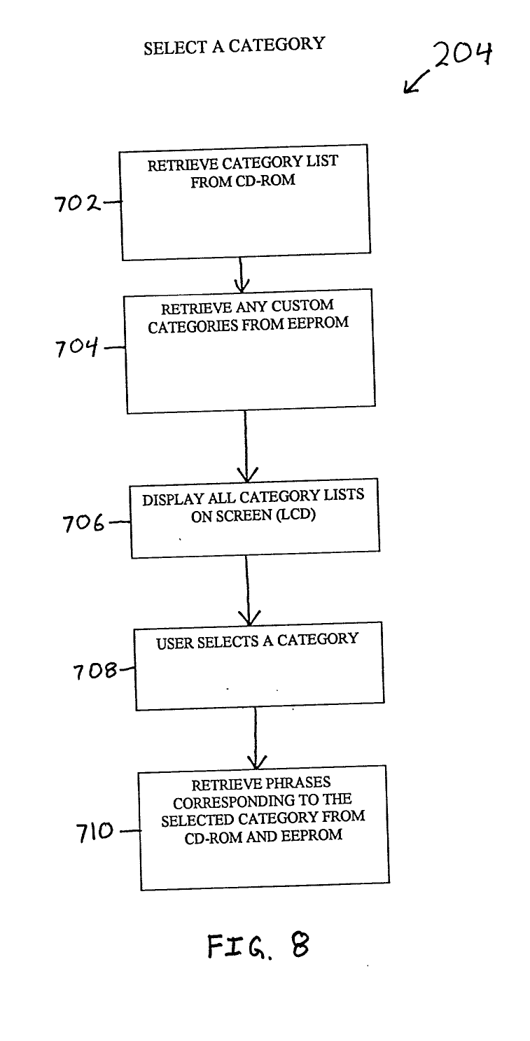

Referring to FIG. 8, there is illustrated an exemplary process that may be used for implementing the select a category step 204 in the main operation 200. In step 702 a category list is retrieved from the CD-ROM 84 or a similar memory. The categories included on the CD-ROM 84 will normally be generic or “canned” categories that are prerecorded on the CD. In step 704 the system retrieves any categories that are stored on the EEPROM 86. The categories stored in the EEPROM 86 will typically be user defined or “custom” categories that the user has programmed into the communication device 20. The system displays all of the categories on the display 24 in step 706. The user typically scrolls through the list of categories and then makes a selection in step 708.

In step 710 the system retrieves the phrases that correspond to the selected category. The canned phrases are typically retrieved from the CD-ROM 84, and the user defined custom phrases are typically retrieved from the EEPROM 86. The device 20 preferably includes a feature that allows a user to define any custom category that he or she chooses. For example, an Electrical Engineer (EE) traveling on business might create an “EE” category for storing technical questions that are commonly asked. The programming of custom categories and phrases is discussed below.

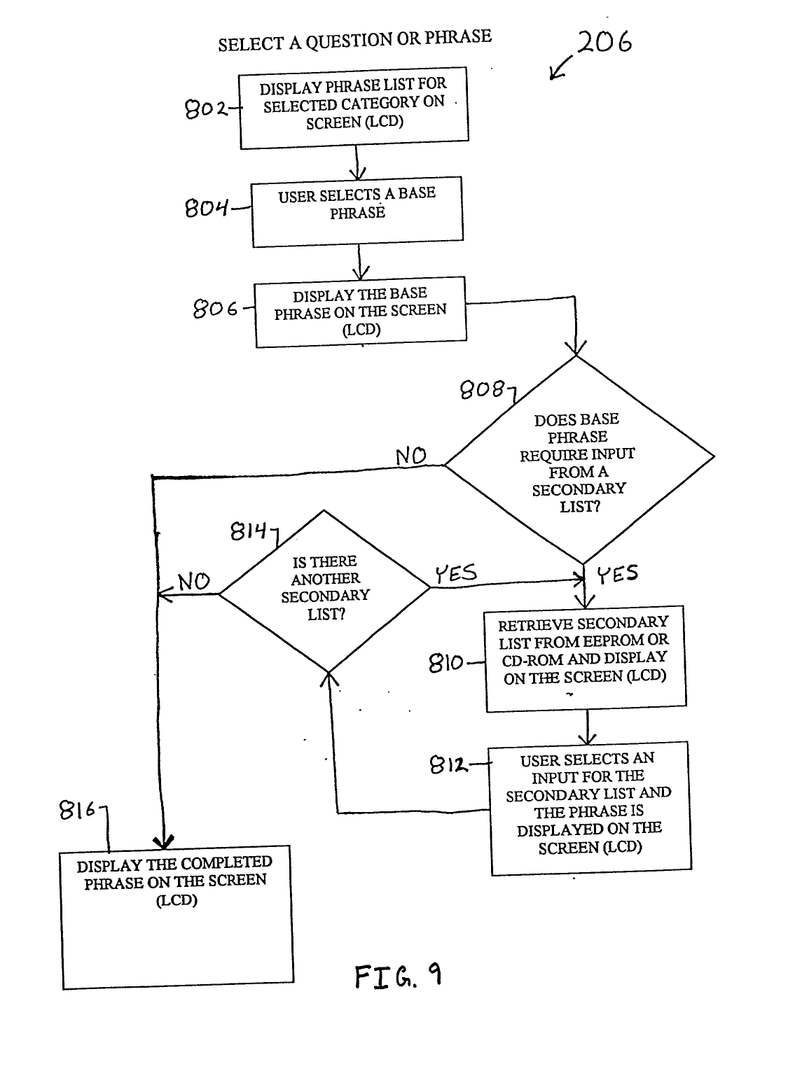

Referring to FIG. 9, there is illustrated an exemplary process that may be used for implementing the select a phrase step 206 in the main operation 200. In step 802 the system displays the retrieved phrases for the selected category on the display 24. Similar to categories, phrases can be either canned phrases stored on the CD-ROM 84 or user defined custom phrases stored in the EEPROM 86. In step 804 the user selects a base phrase from the displayed phrases. As used herein, the term “base phrase” means either a complete phrase (e.g., Where is the closest restaurant?) or a phrase that requires selecting additional information from a secondary list (e.g., Where is the closest ______?). The system displays the selected base phrase on the display 24 in step 806.

In step 808 the system checks whether or not the selected base phrase requires additional information from a secondary list. If so, then a secondary list is retrieved from the CD-ROM 84 and/or EEPROM 86 and displayed on the display 24 in step 810. The secondary list provides selections that can be inserted into the underlined portion of the base phrase. In the above example where the base phrase is “Where is the closest ______?”, the secondary list might include: hotel, restaurant, shopping center, bank, etc. In step 812 the user selects one of the options from the secondary list and the revised phrase is displayed on the display 24 in the user's language.

In step 814 the system checks whether or not additional information from another secondary list is needed. Another secondary list is typically needed where the base phrase includes multiple underlined portions. If such additional secondary list is needed the system repeats steps 810 and 812 to allow the user to select from another secondary list, which results in the revised phrase being displayed on the display 24. Steps 814, 810 and 812 are repeated until the phrase is completed. Once the phrase is completed, i.e., no further secondary lists are needed, the completed phrase is displayed on the display 24 in the user's language in step 816. As discussed above with respect to the main operation 200, the completed phrase is then played, preferably through the speaker 50, in the target language in step 210.

The following are exemplary phrases that could be used as canned phrases for the exemplary categories mentioned above. These phrases are typically stored on a CD-ROM 84.

ARRIVAL:

“Could you please point to the location of customs?”

“I have nothing to declare.”

“I am carrying no food.”

“I am here on business.”

“I am here on vacation.”

“Could you please point to where I get my luggage?”

“Is it upstairs?”

“Is it downstairs?”

“Is it on this floor?”

“Could you please point to where the baggage carts are?”

“Could you please point to where are the buses?”

“Could you please point to where is an elevator?”

“Could you please point to where is the subway?”

“Could you please point to where I can catch a taxi?”

“Could you please point to where I can rent a car?”

“Do you have Economy cars?”

“Do you have Mid-size cars?”

“Do you have large-size cars or mini-vans?”

“I have ______ bags.” <Pick number from Secondary List>

DEPARTURE:

“Could you please point to where ______ Airlines is?” <Pick airline from Secondary List>

“Can I check the bags at the curb?”

“I have ______ bags.” <Pick number from Secondary List>

“May I carry this on the plane?”

“Could you point to where the baggage carts are?”

“Could you please point to where the rental car must be returned?”

TAXI:

“Please take me to my hotel”

“Please take me to hotel ______” <Pick name from Secondary List>

“Please take me to ______” <Pick from Secondary List>

“Approximately, how much will it be, please?”

“How much do I owe you, please?

“Is this enough?”

“How far is ______?” <Pick from Secondary List>

HOTEL:

“I would like to check in, please.”

“I would like at least a single bed, please.”

“I would like a room with a bath, please.”

“I would like a room with a bath on the same floor, please.”

“Do you have a pool?”

“Do you have a gym?”

“Do you have a sauna?”

“Do you have Thermal Baths?”

“Could you point to where the pool is?”

“Could you point to where the sauna is?”

“Could you point to where the Thermal Baths are?”

“My name is ______.” <Get name from personal information>

“I have a reservation.”

“I am staying ______ nights.” <Pick number from a Secondary list>

“How much is it?”

“Could you show me when I have to check out, please?”

“Do you take Credit Cards for payment?”

“Does it include breakfast?”

“I would like an iron, please.”

“The phone does not work.”

“How do I get an outside line?”

“When do I have to check out?”

“May I check out late?”

RESTAURANT:

“Do you have salad?”

“Do you have fish?”

“Do you have beef?”

“Is it roasted?”

“Is it baked?”

“Is it boiled?

“Do you have ______?” <Pick from Secondary List>

“May I have a glass of water, please?”

“May I have a cup of coffee, please?”

“May I have a glass of wine, please?”

“May I have a caraf of hot sake, please?”

“May I have a caraf of cold sake, please?”

“May I have a glass of Cola, please?”

“May I have a glass of soda water, please?”

“May I have some tea, please?”

“Can I have ______, please? <Pick from Secondary List>

“Could you write down the name of a good restaurant?”

“Can you give me the name of a ______ restaurant to give to a Taxi Driver?” <Pick from Secondary List>

“May I have some steamed rice, please?

“May I have some fried rice, please?

BASIC NEEDS:

“I am hungry.”

“I am thirsty.”

“I am hot.”

“I am cold.”

“Could you please point to where the bathrooms are?”

“Could you please point to where a drinking fountain is?”

“I need some tooth paste.”

“I need some mouthwash.”

“I need some dental floss.”

“I need shampoo.”

“I need hair conditioner.”

“I need a comb.”

“I need some finger nail clippers.”

TIME:

“Could you please show me what time the movie starts?”

“Could you please show me what time the show starts?”

“Could you please show me when the Bus leaves?”

“Could you please show me when the Bus arrives?”

“Could you please show me when the Train leaves?”

“Could you please show me when the Train arrives?”

MOVIES & THEATER:

“I would like ______ tickets, please.” <Pick number from Secondary List>

“I would like to see the Theater.”

BUSINESS:

“My name is ______ from ______ corporation.”<From General Program info>

“I am here to see ______” <Speak name into Mic now>

PHONE: “May I speak to ______” <Pick from Secondary List>

PHONE: “I will call back in ______ hours.” <Pick from Secondary List>

“When will he/she be back?”

“I am staying at Hotel ______.”

“My phone number is ______”

“I will be in town till ______.”

“May I take you to lunch?”

“I will be going to ______ on ______.”

POST OFFICE:

“I would like to mail these cards.”

“I would like to mail these envelopes.”

“I would like to mail this package.”

BASIC EXPRESSIONS:

“Do you speak English?”

“Do you speak ______?” <Pick from a Secondary List>

“I am ______ years old. <Pick from a Secondary list>

“How old are you?”

“Are you married?”

“Do you have children?”

“How many children do you have?”

“Can you draw a map?”

“I am cold.”

“I am hot.”

“Could you please point to where the bathrooms are?”

“Could you please point to where a drinking fountain is?”

“Do you understand?”

GETTING AROUND:

“Could you please point to where the Subway Station is?”

“Could you please point to where the Bus Station is?”

“Could you please point to where I may catch a Cab?”

“I would like a round way ticket.”

“I would like a window seat.”

“I would like an aisle seat.”

“I would like to go to ______”. <Pick from Secondary List>

“How long does it take to get to the airport?”

“Pick from selection”

“Could you point to the direction of the nearest Gas Station?”

DOCTOR:

“I am allergic to certain foods.”

“I am allergic to penicillin.”

“I am allergic to shell fish.”

“I have a rash.”

“I have eczema.”

“I have a fever.”

“I have a headache.”

“I have a heart condition.”

“I have high blood pressure.”

“I need to have my prescription renewed.”

“My ______ hurts.” <Pick from secondary List>

SHOPPING:

“My I see that?”

“How much does it cost?”

“May see one that is ______ in color?” <Pick from Secondary List>

“I would like to see socks.”

“I would like to see shirts.”

“I would like to see pants.”

“I would like to see dresses.”

“I would like to see blouses.”

“I would like to see underwear.”

“I would like to see belts.”

“I would like to see hats.”

“I would like to see ______.” <Pick from Secondary List>

“Please write down the best place to buy ______.”<Pick from a Secondary List>

“Do you have one in a different color?”

“Do you have a larger one?”

“Do you have a smaller one?”

EMERGENCIES:

“My wallet has been stolen.”

“My purse has been stolen.”

“One of my bags has been stolen.”

“My laptop has been stolen.”

“There has been an accident.”

“I don't feel well. Can you get a doctor?”

“My wife does not feel well. Can you get a doctor?”

“My child does not feel well. Can you get a doctor?”

The following are examples of some of the secondary lists that could be available to a user.

RESTAURANT LIST:

Chinese, French, Italian, Japanese, Fast Food Japanese, Fast Food Western, Donut Shop, Noodle

NUMBER LIST:

1, 2, 3, 4, 5, 6, 7, 8, 9, 10, 11, 12, 13, 14, 15, 16, 17, 18, 19, 20, 21, 22, 23, 24, 25, 26, 27, 28, 29, 30

BODY LIST:

toe, foot, ankle, calf, knee, hip, buttock, groin, lung, heart, stomach, liver, pancreas, torso, breast, chest, nipple, back, spine, rib, shoulder, arm, elbow, wrist, hand, finger, thumb, index finger, little finger, neck, head, eyes, eyelid, eyelash, eyebrow, cornea, iris, mouth, tongue, tooth, gum, tooth crown, tooth filing, tooth cavity, throat, ears, hair, cheek, forehead, chin, skin, finger nail, cuticle

AIRLINE LIST:

American, Delta, Air France, British Airways, United

COLOR LIST:

red, orange, yellow, green, blue, indigo, violet, white, black, pink, aqua-marine

COUNTRY LIST:

Afghanistan, Bolivia, Canada, Denmark, Ecuador, England, France, . . . Germany, Greece, Ireland, Italy, Mexico, Peru, Russia, Spain, Sweden, Turkey, United States, Russia, Vietnam

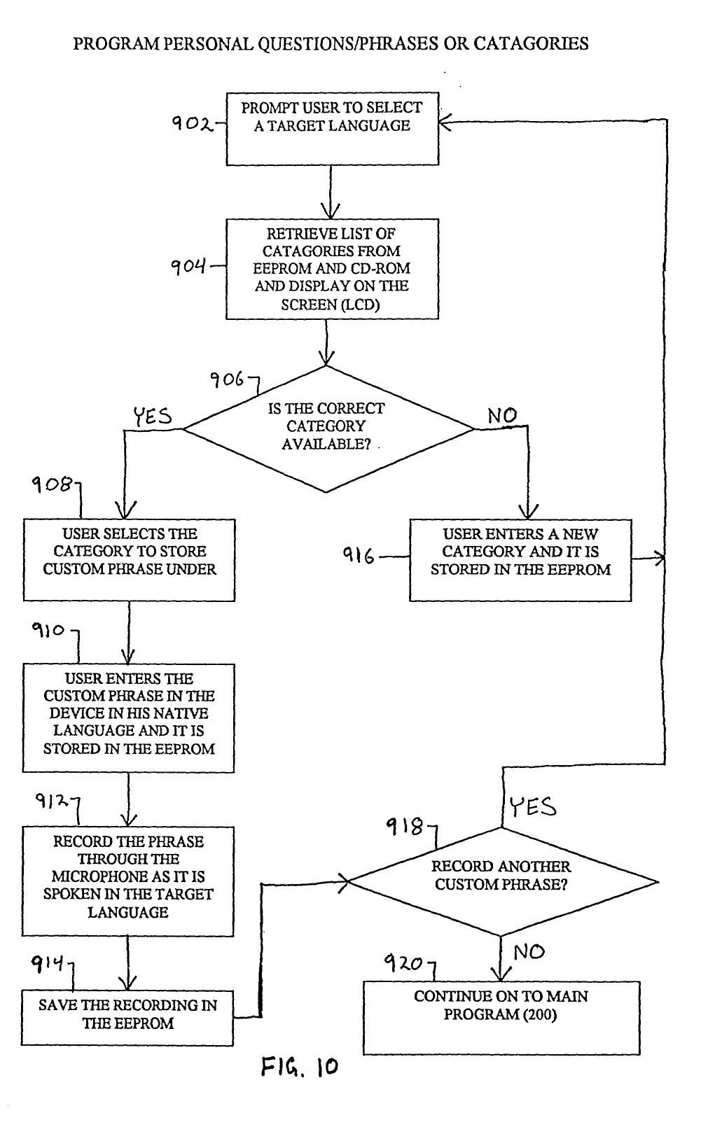

Referring to FIG. 10, there is illustrated an exemplary process that may be used for programming user defined custom phrases and categories in accordance with an embodiment of the present invention. This feature is useful because the canned phrases on prerecorded CDs will not always be appropriate for a user's specific situation. For special situations the user can record his or her own phrases. It should be well understood that the use of custom phrases is an optional feature of the present invention.

The process begins in step 902 with the system prompting the user to enter or select a target language. In step 904 the system retrieves a list of all current categories in the CD-ROM 84 and the EEPROM 86. These categories include both the canned categories and any user defined categories. In step 906 the user decides whether or not his or her desired category is in the list of categories. If the category the user wants to store the custom phrase under is not available, the user creates a new custom category in step 916. The new custom category is stored in the EEPROM 86 and steps 902, 904 and 906 are repeated.

If the correct category is available, then the user selects that category from the list in step 908 by using the buttons on the communication device 20. In step 910 the user types the custom phrase into the device 20 in the user's language. The text of the custom phrase is then stored in the EEPROM 86. In step 912 the custom phrase is recorded through the microphone 44 as it is spoken in the target language. Because the user is typically unable to speak the target language, the user can record the phrase by having somebody else speak the phrase into the microphone 44 in the target language. In step 914 the recorded phrase is stored in the EEPROM 86 as an audio file, which may be one of the audio file types described above. The recorded phrase is categorized under the target language and the selected category. In step 918 the user is given the option to record another custom phrase. If the user wishes to record another custom phrase, then control is passed back to step 902. Otherwise, the system continues on to the main operation 200.

Some user defined custom phrases may need to utilize secondary lists. In this scenario the system preferably allows the user to determine whether or not one of the stock or custom secondary lists on a CD-ROM 84, or an existing secondary list on the EEPROM 86, can be used. If so, the system prompts the user to identify the secondary list. The system then links the recorded phrase to the identified secondary list on the CD-ROM 84 or EEPROM 86. If no existing secondary list can be used, the system prompts the user to enter a new secondary list. The new secondary list is saved in the EEPROM 86, and the recorded phrase is linked to the new secondary list.

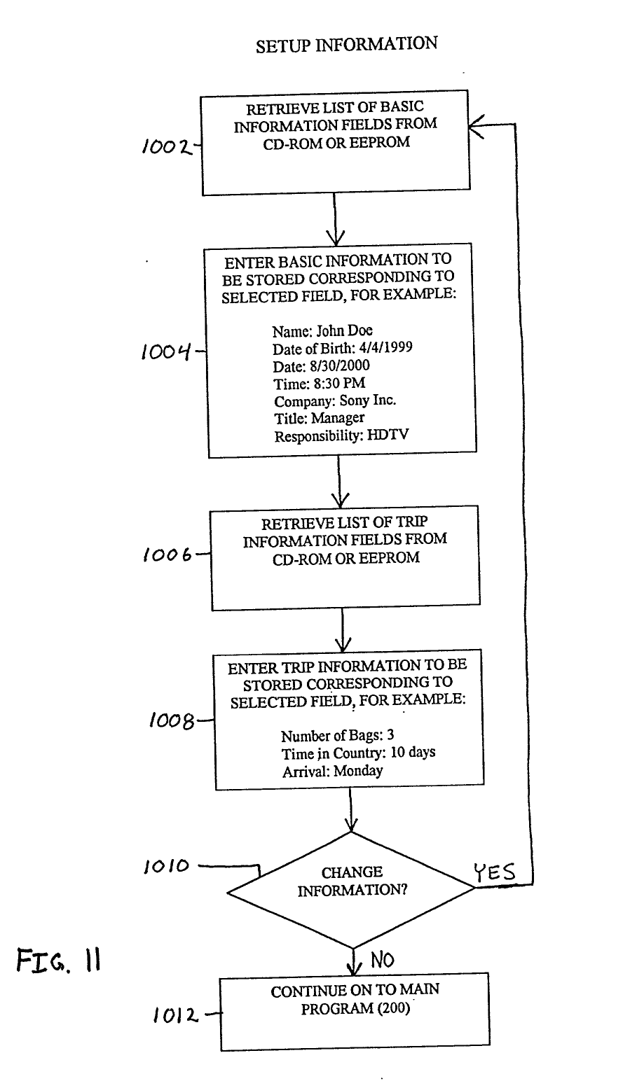

Referring to FIG. 11, there is illustrated an exemplary process that may be used for entering personal information into the communication device 20 in accordance with an embodiment of the present invention. A new device 20 is preferably configured with personal information such as name, age, birth date, current date and time, company affiliation, address, nationality, sex, marital status, customs, family, clothing preferences and sizes, entertainment preferences, tourist preferences, professional background, educational background, hobbies, financial information, travel origination and destination, food preferences, etc. While in route to the host country, the traveler can initialize the device 20 with such specific travel information such as number of bags, time in country, purpose of visit, etc. With this type of device 20 programming the device 20 is personalized by the user and the use of canned phrases thereafter are specific to that user, e.g. DOB, name, age, etc.

The process begins in step 1002 where the system retrieves a list of basic information fields from the CD-ROM 84 and/or EEPROM 86 and displays the information fields on the display 24. The user enters and stores information that corresponds to the selected field in step 1004. By way of example, basic information fields can include name, date of birth, date, time, company, title, responsibility, hobbies, food preference, etc. In step 1006 the system retrieves a list of trip information fields from the CD-ROM 84 and/or EEPROM 86 and displays the fields on the display 24. The user enters and stores information that corresponds to the selected fields in step 1008. By way of example, trip information fields can include number of bags, time in country, arrival, departure. The user has the option to change any of the entered information in step 1010. If information needs to be changed, steps 1002, 1004, 1006, and 1008 are repeated. If the user does not wish to enter more information in one of the fields or change information, then in step 1012 the system returns to the main operation 200.

Prior to arrival to subsequent countries, the user merely needs to change the CD-ROM 84 to one for the new country. All the programmed personal information will apply to the new language unless modified. For example, the specific trip information might be modified such that the time in the country might be different but the number of bags remaining the same.

In another embodiment of the present invention, the communication device 20 may be given to the helper to extract information, such as the personal information described above. In this scenario the helper might be a police officer, customs agent, or other similar person. Because the helper will have access to the device 20 and its information, the device 20 preferably includes means for restricting access to certain information. The access restricting means preferably allows the user to designate which people or type of people have access to certain information, the level of access granted to specific people, and the specific information that corresponds to each access level. The information would then be displayed in the helper's native language, i.e. the target language.

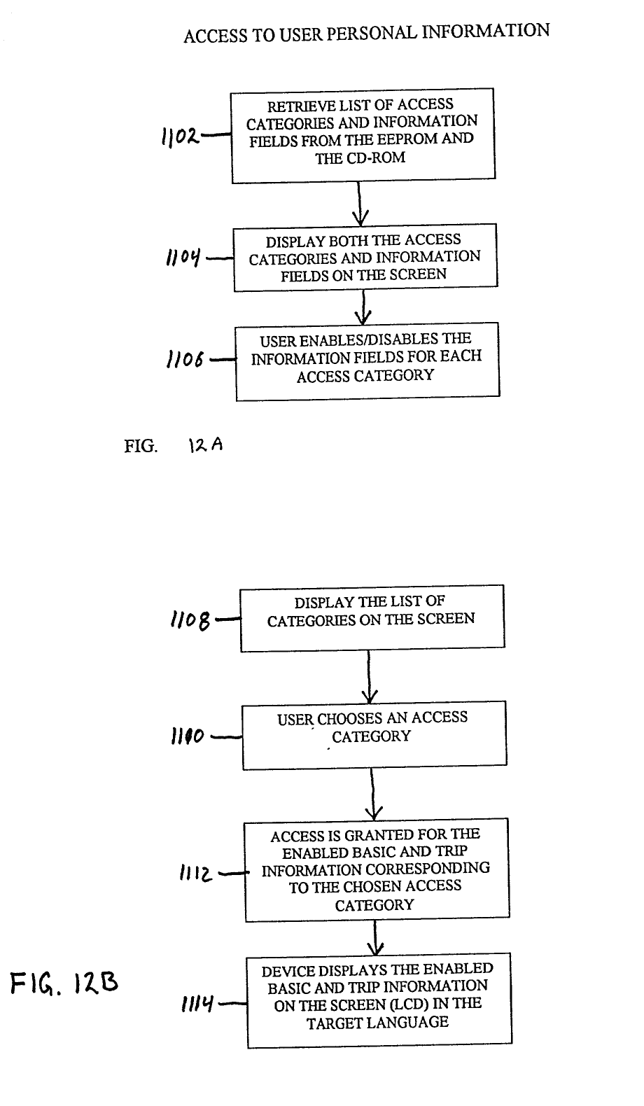

FIG. 12A illustrates an exemplary process that may be used for implementing an access restriction scheme in the communication device 20 in accordance with an embodiment of the present invention. The process illustrates one manner in which the communication device 20 could allow or block access to the personal information of the user. The device 20 preferably requires entry of a password or PIN in order to modify the access restriction scheme so that only the owner of the device 20 can control the access to any personal information. Thus, in order to change data from inaccessible to accessible, a PIN is preferably required.

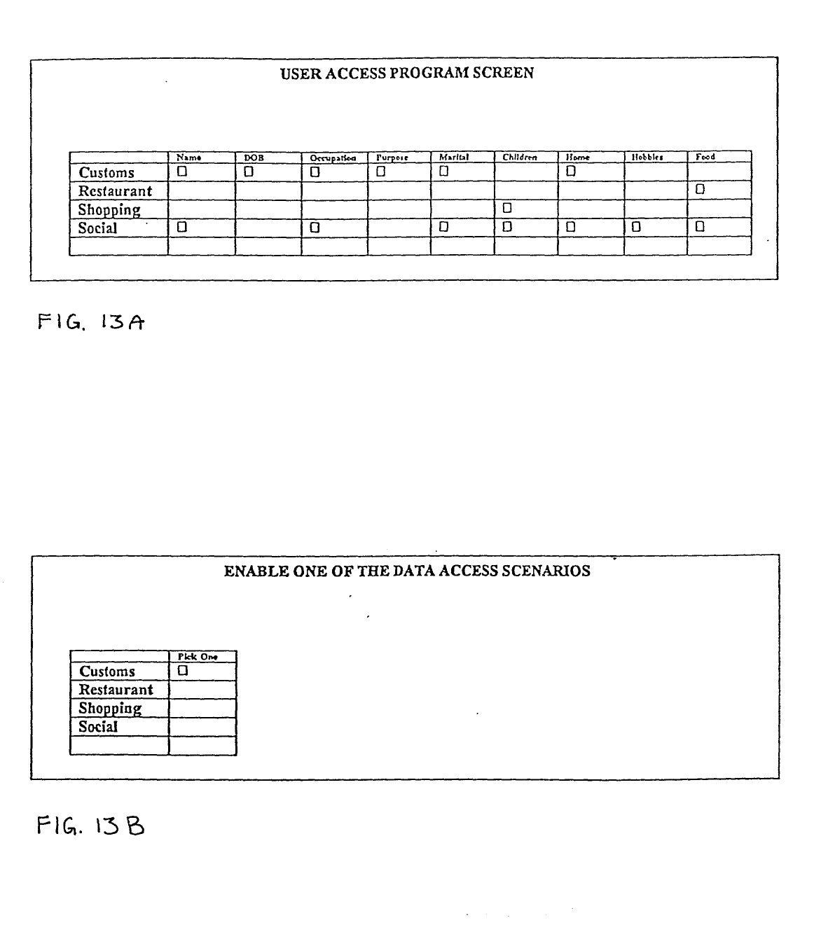

In step 1102 the system retrieves a list of access categories and personal information fields from the EEPROM 86 and CD-ROM 84. The list of access categories and personal information fields are displayed on the display 24 in step 1104. In step 1106 the user selects which basic and/or trip information will be available for each of the access categories. For example, FIG. 13A illustrates the type of access categories that could be available and what information would be available depending on the category selected. The illustrated information categories include Customs, Restaurant, Shopping, and Social. Additional categories could include Police and Business. As shown, the user can select the information that would be available to each access category by checking the corresponding box.

With this scheme the user can set levels of access quickly. For example, if the user were at the Customs office, he or she might set everything to accessible except for the information about clothing sizes. However, if the user were eating out at a restaurant, then he or she might only allow name, occupation, and home to be accessed.

FIG. 12B illustrates an exemplary process for viewing information stored in the communication device 20 once access levels have been set. Specifically, when a user is going to interact with a helper who fits into one of the defined categories, the user selects an access category so that the proper personal information is made available to the helper. In step 1108 the communication device 20 displays the list of access categories on the display 24. The user selects the proper access category in step 1110. In step 1112 the system grants access to the enabled basic and trip information that corresponds to the selected access category. The system displays the enabled basic and trip information on the display 52 in the target language in step 1114.

By way of example, FIG. 13B shows that the user has selected “Customs” as the access category. Referring back to FIG. 13A, the device 20 would display the personal information that was enabled for “Customs”, which is Name, DOB, Occupation, Purpose, Marital, and Home. The device 20 would block access to information about the user's Children, Hobbies and Food.

Thus, the communication device 20 provides an easy and convenient way to communication while in a foreign country. The communication device 20 could also include several enhanced capabilities, which it should be well understood are optional features. For example, the CD-ROM 84 or similar type of memory could be used to store travel maps, pictures, and descriptions of points of interest so that these items could be accessed using the device 20. The history and culture of various countries, cities, communities could also be included. The music of various countries could be included. Or the device 20 could be used for listening to contemporary music on CDs. The CD-ROM 84 could include navigation directions and tour guide tape or audio files for famous sites, museums, temples, shrines, shopping districts, etc. Various “survival guides” could be included, such as for example, how to get around on the Japanese subway system. Emergency instructions and contact information could be included, as well as foreign embassy information. Address, phone numbers, and long distance access instructions could also be included.

As another optional feature, the device 20 could be used to provide beginning, medium, and advanced instructional courses for learning the target or host language, and these courses could be stored on the CD-ROM 84. With such courses a student could record responses into the device 20 for comparison with reference responses. Similarly, the device 20 could be used for generic interactive instruction to learn computer languages, math, reading, geography, history, etc.

While the invention herein disclosed has been described by the specific embodiments and applications thereof, numerous modifications and variations could be made thereto by those skilled in the art without departing from the scope of the invention set forth in the claims.

What is claimed is:

1. A method of communicating, comprising the steps of:
receiving one or more input commands in a communication device;
outputting instructions in a target language from the communication device in response to a received input command, the instructions request a non-verbal response to a phrase;
receiving a selection of the phrase from a list of phrases in a user's language; and
outputting the phrase in the target language from the communication device.

2. A method in accordance with claim 1, wherein the step of outputting instructions comprises the step of:
outputting all instructions in a set of instructions.

3. A method in accordance with claim 1, wherein the step of outputting instructions comprises the step of:
outputting a selection of instructions in a set of instructions.

4. A method in accordance with claim 1, wherein the step of outputting instructions comprises the step of:
outputting to one of a speaker, built-in on screen display, external on screen display, wireless interface, universal serial bus, IEEE 1394, infrared interface, and serial interface.

5. A method in accordance with claim 1, wherein the step of receiving one or more input commands comprises the step of:
receiving one or more input commands from one of a built-in button, external keyboard, internal microphone, wireless interface, universal serial bus, IEEE 1394, infrared interface, and serial interface.

6. A method in accordance with claim 3, wherein the selection of instructions is based on the phrase.

7. A method in accordance with claim 1, further comprising the steps of:
displaying a list of responses in the target language; and
receiving a selection of one of the responses.

8. A method in accordance with claim 1, further comprising the steps of:
displaying a list of phrase categories in the user's language; and
receiving a selection of one of the phrase categories.

9. A method in accordance with claim 1, wherein the step of receiving a selection of the phrase further comprises the step of:
receiving a selection of a portion of the phrase from a secondary list.

10. A method in accordance with claim 1, further comprising the steps of:
storing text in the user's language corresponding to a custom phrase; and
storing audio in the target language corresponding to the custom phrase.

11. A method in accordance with claim 1, further comprising the steps of:
displaying a list of personal information fields in the user's language; and
receiving data corresponding to one of the personal information fields.

12. A method in accordance with claim 1, further comprising the steps of:
displaying a list of access categories and information fields; and
receiving a selection to enable or disable one of the information fields for one of the access categories.

13. A method in accordance with claim 12, further comprising the steps of:
receiving a selection of one of the access categories; and
displaying the information fields that are enabled for the selected access category.

14. A method in accordance with claim 1, wherein the instructions further comprise stating a purpose of the communication device.

15. A method in accordance with claim 1, wherein the instructions further comprise stating how to respond with a yes or no answer.

16. A method in accordance with claim 1, wherein the instructions further comprise stating how to respond to a request for directions.

17. A method in accordance with claim 1, wherein the instructions further comprise stating how to respond to a request for a number.

18. A method in accordance with claim 1, wherein the instructions further comprise stating how to respond to a request for time.

19. A method in accordance with claim 1, wherein the instructions further comprise stating how to choose from a list of possible answers.

20. An apparatus for communicating comprising:
input controls for receiving commands from a user;
a speaker; and
a processing system configured to play instructions in a target language from the speaker in response to interaction with the input controls, wherein the instructions request a non-verbal response to a phrase;
the processing system further configured to receive a selection of the phrase from a list of phrases in a user's language and to play the phrase in the target language from the speaker.

21. An apparatus in accordance with claim 20, wherein the processing system is further configured to play all instructions in a set of instructions.

22. An apparatus in accordance with claim 20, wherein the processing system is further configured to play a selection of instructions in a set of instructions.

23. An apparatus in accordance with claim 20, wherein the processing system is further configured to display a list of responses in the target language and receive a selection of one of the responses.

24. An apparatus in accordance with claim 20, wherein the processing system is further configured to display a list of phrase categories in the user's language and receive a selection of one of the phrase categories.

25. An apparatus in accordance with claim 20, wherein the processing system is further configured to receive a selection of a portion of the phrase from a secondary list.

26. An apparatus in accordance with claim 20, wherein the processing system is further configured to:
store text in the user's language corresponding to a custom phrase; and
store audio in the target language corresponding to the custom phrase.

27. An apparatus in accordance with claim 20, wherein the processing system is further configured to:
display a list of personal information fields in the user's language; and
receive data corresponding to one of the personal information fields.

28. An apparatus in accordance with claim 20, wherein the processing system is further configured to:
display a list of access categories and information fields; and
receive a selection to enable or disable one of the information fields for one of the access categories.

29. An apparatus in accordance with claim 20, wherein the processing system is further configured to:
receive a selection of one of the access categories; and
display the information fields that are enabled for the selected access category.

30. An apparatus in accordance to claim 20, further comprising:
a headphone connector.

31. An apparatus in accordance to claim 20, wherein the instructions further comprise a description of how the apparatus is to be used.

32. An apparatus in accordance to claim 20, wherein the instructions further comprise instructions on answering a yes or no question.

33. An apparatus in accordance to claim 20, wherein the instructions further comprise instructions on how to give directions.

34. An apparatus in accordance to claim 20, wherein the instructions further comprise instructions on how to respond to a request for numbers.

35. An apparatus in accordance to claim 20, wherein the instructions further comprise instructions on how to choose an answer from a list of answers.

36. An apparatus in accordance to claim 20, wherein the instructions further comprise instructions on answering a yes or no question.

37. A method of communicating, comprising the steps of:
receiving one or more input commands in a communication device;
storing text in a user's language corresponding to a custom phrase;
storing audio in a target language corresponding to the custom phrase;
receiving a selection of the custom phrase from a list of phrases in the user's language; and
outputting the custom phrase in the target language from the communication device.

38. A method in accordance with claim 37, further comprising the steps of:
displaying a list of phrase categories in the user's language; and
receiving a selection of one of the phrase categories.

39. A method in accordance with claim 38, wherein the step of receiving a selection further comprises receiving a selection of a custom phrase category.

40. A method in accordance with claim 37, further comprising the step of:
receiving a selection of a portion of the custom phrase from a secondary list.

41. A method in accordance with claim 37, further comprising the step of:
receiving the audio in the target language through a microphone.

42. A method in accordance with claim 37, further comprising the step of:
receiving input commands in the communication device corresponding to the text in the user's language.

43. An apparatus for communicating comprising:
input controls for receiving commands from a user;
a speaker; and
a processing system configured to store text in a user's language corresponding to a custom phrase and to store audio in a target language corresponding to the custom phrase;
the processing system further configured to receive a selection of the custom phrase from a list of phrases in the user's language and to play the custom phrase in the target language from the speaker.

44. An apparatus in accordance with claim 43, wherein the processing system is further configured to:
display a list of phrase categories in the user's language; and
receive a selection of one of the phrase categories.

45. An apparatus in accordance with claim 44, wherein the list of phrase categories includes a custom phrase category.

46. An apparatus in accordance with claim 43, wherein the processing system is further configured to receive a selection of a custom phrase category.

47. An apparatus in accordance with claim 43, wherein the processing system is further configured to receive a selection of a portion of the custom phrase from a secondary list.

48. An apparatus in accordance with claim 43, further comprising:
a microphone;
wherein the processing system is further configured to receive the audio in the target language through the microphone.

49. A method of communicating, comprising the steps of:
storing personal information in a communication device using a user's language; and
outputting the information from the communication device in a target language.

50. A method in accordance with claim 49, wherein the step of outputting the information is access controlled by the user.

51. A method in accordance with claim 50, wherein the access categories controlled by the user are selected from one or more of name, age, birth date, current date and time, company affiliation, address, nationality, sex, marital status, customs, family, clothing preferences and sizes, entertainment preferences, tourist preferences, professional background, educational background, hobbies, financial information, travel origination and destination, and food preferences.
